(19) United States
(12) Patent Application Publication
(10) Pub. No.: US 2015/0076335 A1
(43) Pub. Date: Mar. 19, 2015

(54) COMPOSITE HIGH TEMPERATURE GAMMA RAY DETECTION MATERIAL FOR WELL LOGGING APPLICATIONS

(71) Applicants: Maxim Vasilyev, The Woodlands, TX (US); Valery N. Khabashesku, Houston, TX (US); Andrei Fedorov, Minsk (BY); Mikhail Korjik, Minsk (BY)

(72) Inventors: Maxim Vasilyev, The Woodlands, TX (US); Valery N. Khabashesku, Houston, TX (US); Andrei Fedorov, Minsk (BY); Mikhail Korjik, Minsk (BY)

(73) Assignee: BAKER HUGHES INCORPORATED, Houston, TX (US)

(21) Appl. No.: 14/484,581

(22) Filed: Sep. 12, 2014

Related U.S. Application Data
(60) Provisional application No. 61/877,559, filed on Sep. 13, 2013.

(51) Int. Cl. G01V 5/04; E21B 49/00

(52) U.S. Cl. CPC G01V 5/04; E21B 49/00
USPC 250/259; 250/256

(57) ABSTRACT

An apparatus for detecting a gamma-ray includes: a gamma-ray detection material comprising a material transparent to light having a plurality of nano-crystallites where each nano-crystallite in the plurality has as periodic crystal structure with a diameter or dimension that is less than 1000 nm and includes (i) a heavy atom having an atomic number greater than or equal to 55 that emits an energetic electron upon interacting with an incoming gamma-ray and (ii) and an activator atom that provides for scintillation upon interacting with the energetic electron to emit light photons wherein the heavy atom and the activator atom have positions in the periodic crystal structure of each nano-crystallite in the plurality; and a photodetector optically coupled to the gamma-ray detection material and configured to detect the light photons emitted from the scintillation and to provide a signal correlated to the detected light photons.

### CROSS REFERENCE TO RELATED APPLICATIONS

This application claims the benefit of an earlier filing date from U.S. Provisional Application Ser. No. 61/877,559 filed Sep. 13, 2013, the entire disclosure of which is incorporated herein by reference.

### BACKGROUND

Geologic formations are used for many purposes such as hydrocarbon production, geothermal production and carbon dioxide sequestration. In general, formations are characterized in order to determine if the formations are suitable for their intended purpose.

One way to characterize a formation is to convey a downhole tool through a borehole penetrating the formation. The tool is configured to perform measurements of one or more properties of the formation at various depths in the borehole to create a measurement log.

Many types of logs can be used to characterize a formation. In one type of log referred to as a natural gamma ray log, a gamma ray detector is disposed in a downhole tool. As the downhole tool is conveyed through the borehole, the gamma ray detector detects natural gamma rays emitted from the formation. The detector response is recorded and analyzed. From the energy peaks displayed from the detector response, the presence of certain minerals in the formation can be determined. In another type of downhole tool, a gamma ray detector is configured to detect gamma rays resulting from irradiating the formation with neutrons in order to estimate formation density or porosity. It can be appreciated that improving the sensitivity of the gamma-ray detector can improve the accuracy of the formation characterization.

### BRIEF SUMMARY

Disclosed is an apparatus for detecting a gamma-ray. The apparatus includes: a gamma-ray detection material comprising a material transparent to light having a plurality of nano-crystallites where each nano-crystallite in the plurality has as periodic crystal structure with a diameter or dimension that is less than 1000 nm and includes (i) a heavy atom having an atomic number greater than or equal to 55 that emits an energetic electron upon interacting with an incoming gamma-ray and (ii) and an activator atom that provides for scintillation upon interacting with the energetic electron to emit light photons wherein the heavy atom and the activator atom have positions in the periodic crystal structure of each nano-crystallite in the plurality; and a photodetector optically coupled to the gamma-ray detection material and configured to detect the light photons emitted from the scintillation and to provide a signal correlated to the detected light photons.

Also disclosed is an apparatus for estimating a property of an earth formation penetrated by a borehole. The apparatus includes: a carrier configured to be conveyed through the borehole; a gamma-ray detector disposed at the carrier and comprising a gamma-ray detection material, the gamma-ray detection material having a material transparent to light having a plurality of nano-crystallites where each nano-crystallite in the plurality has as periodic crystal structure with a diameter or dimension that is less than 1000 nm and includes (i) a heavy atom having an atomic number greater than or equal to 55 that emits an energetic electron upon interacting with an incoming gamma-ray and (ii) and an activator atom that provides for scintillation upon interacting with the energetic electron to emit light photons wherein the heavy atom and the activator atom have positions in the periodic crystal structure of each nano-crystallite in the plurality; a photodetector optically coupled to the neutron detection material and configured to detect the light photons emitted from the scintillation and to provide a signal correlated to the detected light photons; and a processor configured to estimate the property using the signal.

Further disclosed in a method for estimating a property of an earth formation penetrated by a borehole. The method includes: conveying a carrier through the borehole; receiving gamma-rays from the formation using a gamma-ray detector, the gamma-ray detector having a material transparent to light having a plurality of nano-crystallites where each nano-crystallite in the plurality has as periodic crystal structure with a diameter or dimension that is less than 1000 nm and includes (i) a heavy atom having an atomic number greater than or equal to 55 that emits an energetic electron upon interacting with an incoming gamma-ray and (ii) and an activator atom that provides for scintillation upon interacting with the energetic electron to emit light photons wherein the heavy atom and the activator atom have positions in the periodic crystal structure of each nano-crystallite in the plurality; receiving the light photons emitted by the scintillation using a photodetector to produce a signal; and estimating the property using a processor that receives the signal.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a downhole tool having a gamma ray detector disposed in a borehole penetrating the earth;

FIG. 2 depicts aspects of a schematic structure of nano-crystallite gamma ray detection material disposed in the gamma ray detector;

FIG. 3 depicts aspects of a first temperature program for synthesizing nano-crystallites in the gamma ray detection material;

FIG. 4 depicts aspects of a second temperature program for synthesizing nano-crystallites in the gamma ray detection material;

FIG. 5 is a flow chart of a method for estimating a property of an earth formation.

### DETAILED DESCRIPTION

Disclosed are apparatus and method for detecting gamma-rays in a downhole tool with improved sensitivity and, hence, accuracy. In one or more embodiments, gamma-rays detected during well logging operations are used to estimate a property of an earth formation such as density, porosity, or mineral composition using processing techniques known in the art.

A detailed description of one or more embodiments of the disclosed apparatus and method presented herein by way of exemplification and not limitation with reference to the Figures.

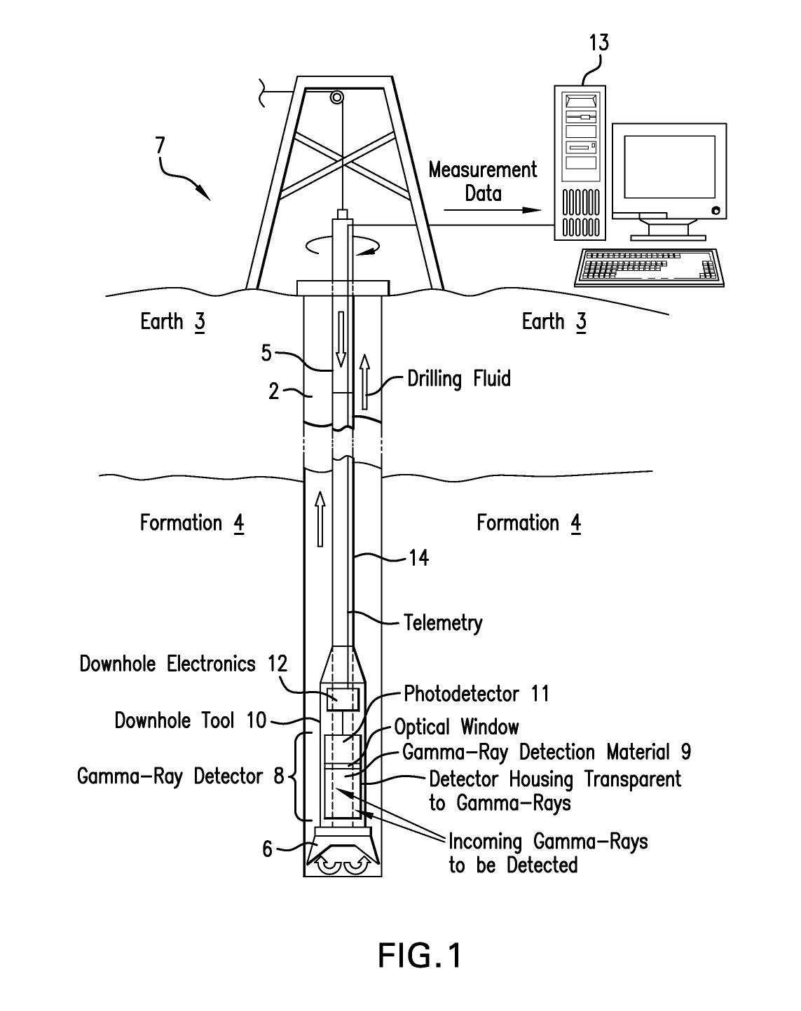

FIG. 1 illustrates an exemplary embodiment of a downhole tool 10 disposed in a borehole 2 penetrating the earth 3, which includes an earth formation 4. The formation 4 represents any subsurface materials of interest. The downhole tool 10 is conveyed through the borehole 2 by a carrier 14. In the embodiment of FIG. 1, the carrier 14 is a drill string 5. Disposed at the distal end of the drill string 5 is a drill bit 6. A drilling rig 7 is configured to conduct drilling operations such as rotating the drill string 5 and thus the drill bit 6 in order to drill the borehole 2. In addition, the drill rig 7 is configured to pump drilling fluid through the drill string 5 in order to lubricate the drill bit 6 and flush cuttings from the borehole 2. The downhole tool 10 is configured to perform formation measurements while the borehole 2 is being drilling or during a temporary halt in drilling in an application referred to as logging-while-drilling (LWD). In an alternative logging application referred to as wireline logging, the carrier 14 is an armored wireline configured to convey the downhole tool 10 through the borehole 2.

Still referring to FIG. 1, the downhole tool 10 includes a gamma-ray detector 8 that is configured to detect gamma-rays emitted by the formation 4. The gamma-ray detector 8 includes a gamma-ray detection material 9 optically coupled to a photodetector 11. An optical window may be used as an interface between the gamma-ray detection material and the photodetector. A housing transparent to gamma-rays may be used to contain the gamma-ray detection material, the optical window and the photodetector. The gamma-ray detection material 9 is configured to interact with an incoming gamma-ray from the formation 4 to generate photons through a scintillation process. The photodetector 11 is configured to detect the generated photons and provide an electrical signal, such as pulses of current or voltage, having a characteristic that corresponds to a physical characteristic of the incoming photon. For example, output from the photodetector may be used to generate a count versus energy plot having one or more peaks, which correspond to one or more chemical elements. Hence, from the detection of the gamma-rays emitted from the formation, one of more properties, such as the chemical composition or presence of certain minerals, can be determined using an output signal from the gamma-ray detector as would be known to one of skill in the art. Non-limiting embodiments of the photodetector 11 include a photo-multiplier-tube (PMT) and a solid-state semiconductor device.

Still referring to FIG. 1, the gamma-ray detector 8 is coupled to downhole electronics 12. The downhole electronics 12 are configured to operate the downhole tool 10, process data from formation measurements, and/or provide an interface for transmitting data to a surface computer processing system 13 via a telemetry system. In one or more embodiments, the downhole electronics 12 can provide operating voltages to the gamma-ray detector 8 and measure or count electrical current or voltage pulses resulting from gamma-ray detection. Processing functions such as counting detected gamma-rays or determining a formation property can be performed by the downhole electronics 12, the surface computer processing system 13, or combination thereof. In one or more embodiments, the processing can include comparing the photodetector output to a reference in order to determine the formation property.

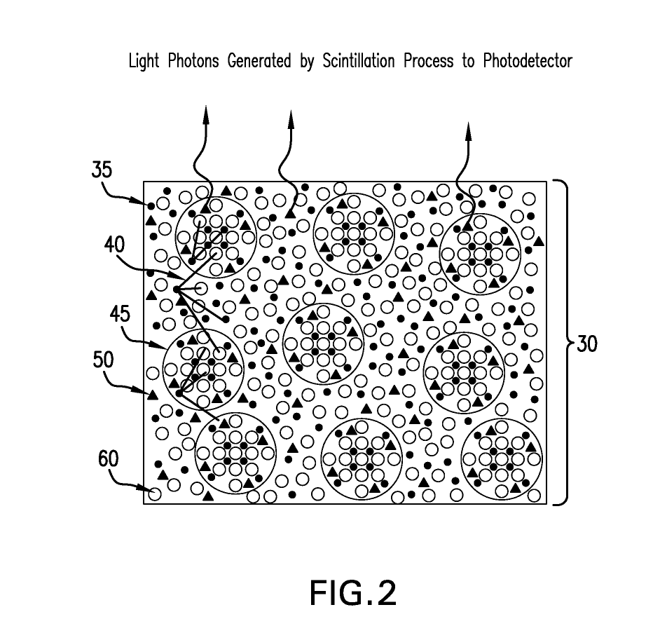

FIG. 2 depicts aspects of a schematic structure of the gamma-ray detection material 9. A plurality of nano-crystallites 45 is disposed in a glass matrix 30. The glass matrix is a material transparent to light and includes atoms 60 such as Al, Si, and O for example. Each nano-crystallite 45 has a periodic crystal lattice structure. Positions in the periodic crystal lattice structure are occupied by a heavy atom 35 and an activator atom 50 (note that there can be at least thousands of heavy atoms and hundreds of activator atoms in addition to light atoms inside a single nano-crystallite). For illustration purposes, the plurality of nano-crystallites 45 is depicted as having a spherical boundary whereas the nano-crystallites may have crystal-shaped boundaries. A diameter or dimension of each of the nano-crystallites 45 is generally in a range of about 100 nm to less than 1000 nm.

The heavy atom 35 has an atomic number greater than or equal to 55. The heavy atom 35 interacts with an incoming gamma-ray (also referred to as γ-quanta) and to emit a “hot” electron 40. The term “hot” relates to an electron or hole having an increase in energy that allows the energetic electron or hole to propagate or travel. The “hot” electron travels and interacts with the activator atom 50 to cause a scintillation process that results in generating a light photon. As discussed above, the generated light photon is detected by the photodetector 11. It can be appreciated that the higher the energy of the incoming γ-quanta (i.e., gamma-ray), the higher will be the total energy of the “hot” electrons that are emitted by the heavy atom 35 resulting in an increase in the number of light photons that are generated and detected. The increase in the number of photons detected will correspond to an increase in the signal or pulse level that is output by the photodetector 11. As illustrated in FIG. 2, the glass matrix 30 external to the nano-crystallites 45 includes heavy atoms 35 and activator atoms 50. In one or more embodiments, the heavy atoms 35 in both the nano-crystallites 45 and the glass matrix 30 external to the nano-crystallites 45 are of the same type (i.e., same element). Similarly, the activator atoms 50 in both the nano-crystallites 45 and the glass matrix 30 external to the nano-crystallites 45 are of the same type (i.e., same element). In alternative embodiments, more than one type of heavy atom 35 and/or activator atom 50 may be in the nano-crystallites 45 and/or the glass matrix 30.

It can be appreciated that the gamma-ray detector 8 having the nano-structured gamma-ray detection material 9 has improved energy conversion efficiency compared to prior art gamma-ray detectors. The improved efficiency is due to the presence of scintillating nano-crystallites 45 in the detector material which are formed in the detector glass body in the process of the controlled recrystallization of some fraction of its volume. Inside these scintillating nano-crystallites atoms form regular structure of crystal lattices, whereas atoms surrounding the nano-crystallites still are distributed randomly forming conventional amorphous (irregular) structure of glass. It is noted that these atoms inside scintillating nano crystallites include heavy atoms 35 and activator atoms 50. In an amorphous structure, only a small part of energy losses of “hot” electrons is converted into scintillation emissions due to inefficient energy transfer to activator atoms 50 and the main part of primarily absorbed energy of γ-quanta is lost ineffectively for material heating, without scintillation. In turn, when γ-quanta propagate inside the nano-crystallites and surrounding amorphous media they produce “hot” electrons 40, all energy losses of “hot” electrons at their interaction with atoms composing crystal lattice can be efficiently (from several to 100 times more efficiently than in an amorphous structure) delivered to activator atoms 50 via exciton mechanism of energy transfer.

Thus, i) placing activator atoms 50 inside scintillating the nano-crystallites increase efficiency of the energy transfer from a “hot” electron to an activator atom due to exciton mechanism and ii) placing heavy atoms 35 inside scintillating nano objects increases number of “hot” electrons created by scintillation in the nano-crystallites, which compensates for the concentration of heavy atoms 35 in a detector material being relatively low, normally no more than 30 atomic %.

It is also noted that, depending on recrystallization process conditions, up to 80% of the total volume of the detector material 30 may be transformed to the nano-crystallites without loss of optical transparency of the detector material. This also means that up to 80% of heavy atoms 35 and activator atoms 50 in the detector material are located inside the nano-crystallites.

Next, aspects of selecting activator atoms and scintillation material are discussed. As a rule, acceptable temperature dependence of the scintillation light yield versus temperature in the range from room to temperature to 200° C. is shown by doped scintillation materials. Examples of scintillation materials which possess such properties are single crystalline compounds activated by Ce³⁺ and Pr³⁺ ions. The scintillation process in these compounds is driven by the interconfiguration radiation transitions 5d→f(Ce³⁺) and 4f5d→f²(Pr³⁺) which have low yield (LY) temperature dependence up to 200° C. For example, such scintillation material as YAlO₃:Ce has a high LY parameter, fast scintillation process and its LY has minor change up to 100° C. Partial replacement of yttrium with lutetium decreases LY value but improves LY temperature dependence LY(T) making it stable up to 200° C. These materials have small effective charge Z_{eff} and are preferable for detection of “soft” (lower energy) γ-rays. Some Pr³⁺ doped materials show even better LY(T) dependence, for instance YAlO₃:Prⁿ, but also has a small Z_{eff}. Scintillation crystal of lutetium aluminum garnet doped with Pr (Lu₃Al₅O₁₂:Pr or LuAG:Pr) demonstrates even growing dependence of LY(T) in the temperature range 50-170° C. At the same time, Lu contains substantial amount of naturally radioactive isotope which emits β-particles. This self-radiation background in the signal of the scintillation detector based on LAG:Pr makes it impossible to use such material in detectors to perform natural gamma ray well logging measurements. Better dependence of LY(T) at high temperatures (less decrease of LY with T increase) for scintillation materials activated by Pr³⁺ in comparison with scintillators based on the same matrix and activated by Ce³⁺ is due to faster kinetics of the interconfigurational radiative transitions. For Pr³⁺, it is about 2 times faster than for Ce³⁺. Due to this fact, the influence of non-radiative relaxations of the excited electronic states on the scintillation process is smaller in materials doped with Pr³⁺.

Composite nano-crystallite material overcomes disadvantages of single crystalline materials. In the composite nano-crystallite material, a favorable combination of heavy atoms in the glass matrix surrounding nano-crystallites also containing heavy atoms can be achieved. Here, main requirements of the nano-crystallites are as follows. First, they have to be nano-sized with dimensions smaller than wavelength of scintillation light to prevent scattering of the light inside the composite. In one or more embodiments, a diameter or dimension of each of the nano-crystallites is at least four times smaller than a wavelength of light emitted by the scintillation. Second, the nano-crystallites have to exhibit high light yield of scintillation, therefore they should be big enough and contain large number crystal lattice unit cells to provide effective exciton mechanism of energy transfer. In case when refractive index of the nano-crystallites is close to that of the glass matrix (which is generally the case when nano-crystallites are produced inside the glass matrix in the process of crystallization), the size of nano-crystallites can be large enough and even comparable with scintillation wavelength without worsening of optical transparency. Therefore, in one or more embodiments, the size of nanoparticles is in range of approximately 100 nm to less than 1000 nm to combine optical transparency with high scintillation efficiency.

Gamma quanta entering the composite nano-crystallite detection material undergo several mechanisms of interaction of gamma quanta with matter in the nano-crystallites. At the energies of gamma quanta below 1 MeV, the most important mechanism is photo-electric effect. With the photo-electric effect, the efficiency of gamma quanta absorption in matter is proportional to the effective atomic number of the matter in a degree varying exponentially from 4 to 5 depending on the energy in a range from 10 keV to 1 MeV (i.e. from Z⁴ to Z⁵).

Effective atomic numbers Z of the components forming the composite nano-crystallite detection material are distributed as follows: Z_{nano-crystallite heavy atoms}>Z_{nano-crystallite scintillator atoms}>Z_{light glass matrix atoms}. (Effective Z for a particular type of atom relates to averaging the atomic number for those types of atoms generally using 3.5 degree averaging in nuclear physics. For example, Z=root 3.5 [X^{3.5}+Y^{3.5}] for atoms X and Y) Due to this fact, the most probable photo-electric absorption of the gamma quanta will occur in the heavy atoms incorporated into the light glass matrix such as Pb, Bi, Ba, Hf, Au, I, and Pt for example and in the nano-crystallites containing the same heavy ions. Some of the hot electrons produced from this interaction will also be absorbed most probably in the heavy atoms incorporated into the light glass matrix such as the Pb, Bi, Ba, Hf, Au, I, and Pt and in the nano-crystallites containing the same heavy ions. However, the amount of hot electrons not absorbed by the heavy atoms is significant and, thus, will be effectively transformed into energy of light scintillation photons.

The “mother's” glass (i.e., the glass surrounding the nano-crystallites) should contain as large a number as possible of heavy atoms which provide high stopping power of γ-quanta by detector material. So nano-crystallites contain and are surrounded by atoms with high absorption to γ-quanta to allow a creation of a large quantity of hot electrons. This detection material is transparent to scintillation light produced by the nano-crystallites. To meet these requirements, heavy atoms such as Pb, Bi, Ba, Hf, Au, I, and Pt are inside the media surrounding the nano-crystallites (and inside the nano-crystallites). Transparency of the surrounding media to scintillation light can be achieved in ceramics, polymer and amorphous glass. Production of the transparent ceramics is an expensive process and limits an amount of possible combinations of host media and nano-crystallites by the requirement of the cubic symmetry of the species. Polymers generally allow the joining nanoparticles and heavy ions in a small quantities, and makes energy transfer between them low. (Also, there is no match of refractive indices of polymer and nano-crystallites due to density differences.) Glass matrix generally allows an infinite number of combinations of atoms. It allows production of transparent media where more than 50% of the atoms are heavy atoms. Another benefit of a glass matrix material with heavy atoms is that is has a high refractive index comparable with that of the nano-crystallites. Precise adjustment of the glass matrix refractive index to match that of the nano-crystallites is possible by variation of the number of heavy atoms in the glass matrix material. However, as disclosed herein the nano-crystallites produced by crystallization inside the glass matrix material inherently have matching refractive indices. While the glass matrix material has certain advantages, ceramics and polymers may also be used in other embodiments.

Next, processes to produce the nano-crystallites in the glass matrix material are discussed. After glass manufacturing to produce glass matrix material having the heavy atoms and the activator atoms, the glass undergoes a heat treatment process. In the heat treatment process, the glass is exposed to a temperature at T which is higher than glass vitrification temperature Tg, but less than the temperature of the avalanche crystallization, for an extended period of time. The main goal of this step is to form nano-crystallites in the glass matrix material.

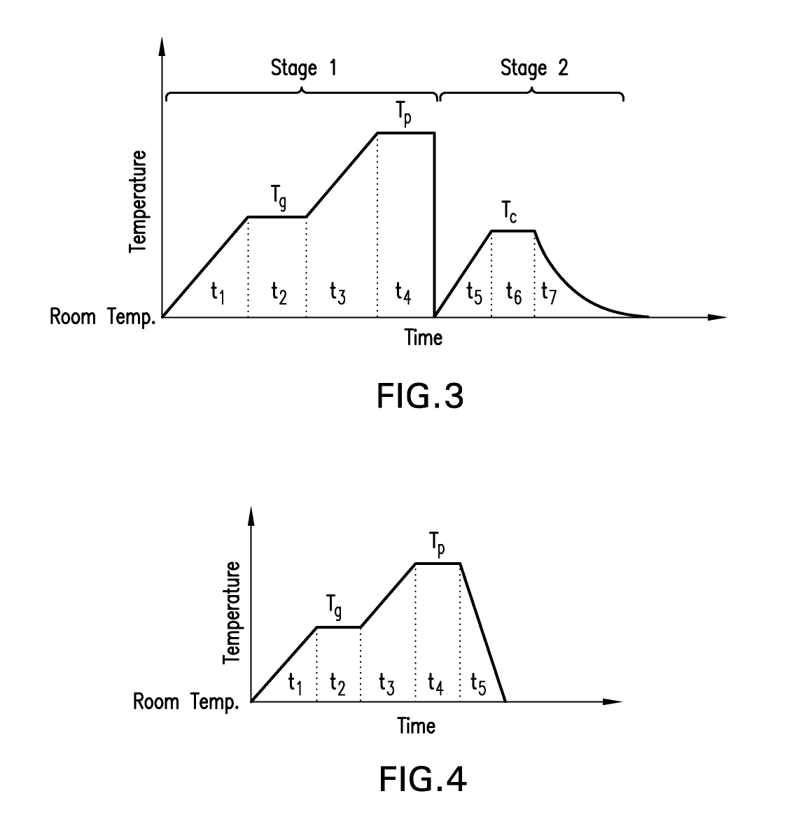

FIG. 3 depicts aspects of a first temperature program for synthesizing nano-crystallites in the glass matrix material. The synthesizing is generally performed using an oven to apply a temperature profile to glass matrix material. Referring to FIG. 3, stage 1 of the synthesis process involves melting the glass matrix material to form a homogeneous glass structure. It includes of several steps. During time period t1, the mixture is heated up to the temperature of vitrification Tg where different parts of the mixture start to smelt to each other and the mixture is kept at this temperature during time period t2 to outgas the material. The duration of t2 is different for different glasses and can vary from 0 to hundreds of hours depending on the glass mixture. During time period t3, the temperature of the material is increased up to the glass melting temperature Tp. The obtained glass melt is kept at this temperature during time period t4 for its homogenization and, after this it is cooled very rapidly at a cooling rate greater than 500° C./min to a temperature at or above room temperature.

The main goal of Stage 2 of the synthesis process in FIG. 3 is to create the nano-crystallites in the glass matrix material by annealing the glass obtained in Stage 1 at temperature Tp, which is higher than glass vitrification temperature Tg, but less than the temperature of the avalanche crystallization of the nano-crystallites. The temperature of the glass after stage 1 is slowly increased during time period t5. Then, the glass is annealed at constant temperature Tc during time period t6. Alternatively, the temperature Tc can be slowly increased during the recrystallization depending on the composition of ingredients in the glass system. The glass matrix material is then cooled to room temperature (generally within the oven) during time period t7.

Nano crystallites also can be obtained in the glass matrix material during stage 1 when glass melt is kept at temperature Tp during time period t4 for its homogenization and then cooled at a controlled cooling rate in the range 20-100° C./min to a temperature at or above room temperature as illustrated in time period t5 in FIG. 4.

A first example of producing the gamma-ray detection material 30 is now presented using the temperature program illustrated in FIG. 3. In this example, a composition 1:2 of chemicals BaO and SiO2 in mol. % and additive of 6 weight % of CeO₂ as an excess to BaO—SiO2 mixture is mixed and heated during time t1=10-60 min in the atmosphere to temperature Tg=480-520° C. and kept at this temperature for t2=1-20 min. The resulting glass is then heated during t3=10-60 min to Tp (1380-1450° C.), kept there for t4=60-1200 min, and then quenched in the mold with the temperature decrease rate of 300-600° C./min. Obtained glass has density of 3.7 g/cm³ and has effective charge Z_{eff} of the compound of 51 which is larger than effective Z_{eff} of NaI(Tl). Obtained glass is then heated during t5=10-60 min to temperature Tc=800-1000° C., kept at this temperature during t6=10-600 min, and cooled in the oven to a temperature at or above room temperature during time t7 (e.g., 30-600 min). This process results in nano-crystallites of barium disilicate, BaSi2O5, containing Ce3+ ions being distributed throughout the glass matrix 30. An indication of the presence of the nano-crystallites is a rise of a strong luminescence band in blue-green region. The Ce³⁺ ions in the barium disilicate have strong luminescence in the blue green region peaked at 480 nm.

In a case when Eu is used as activator atoms, Stage 1 is performed in a reducing atmosphere created in the flame at the burning of the mixture of natural gas and air. This process results in the formation of nano-crystallites of barium disilicate, BaSi2O5, containing Eu²⁺ ions in the glass matrix material. An indication of the presence of the nano-crystallites having Eu²⁺ is a rise of a strong luminescence band in green region. The Eu²⁺ ions in the barium disilicate have strong luminescence in the green region peaked at 510 nm.

One approach to increase the probability of the successful creation of the nano-crystallites during Stage 2 of the synthesis process is to increase duration of the t6 time interval. But, too long of a heat treatment may cause a crystallization of micro crystallites when almost all matter of the mixture is converted into the aggregation of crystallites with sizes exceeding 1000 nm. As a result, instead of transparent glass, non-transparent glass ceramics are produced.

A second example of producing the gamma-ray detection material 30 is now presented using the temperature program illustrated in FIG. 4. In this example, a composition 1:2 of chemicals BaO and SiO2 in mol. % and additive of 6 weight % of CeO₂ as an excess to BaO—SiO2 mixture is mixed and heated during time t1=10-60 min in the atmosphere to temperature Tg=480-520° C. and kept at this temperature for t2=1-20 min. The resulting glass is then heated during t3=10-60 min to Tp (e.g., 1380-1450° C.), kept there for t4=60-1200 min, and then quenched in the mold with the temperature decrease rate 20-100° C./min during time t5=15-70 min. This process results in nano-crystallites of barium disilicate, BaSi2O5, containing Ce³⁺ ions being distributed throughout the glass matrix 30. The Ce3+ ions in the barium disilicate nano-crystallites possess strong luminescence in the blue green region peaked at 480 nm. It can be appreciated that the outputs resulting from using the temperature programs depicted in FIGS. 3 and 4 are generally the same with respect to the nano-crystallites crystallizing in the glass matrix material. In the temperature program of FIG. 4, conditions for creating the nano-crystallites are obtained by slowing the cooling process in time period t5. If the cooling during this program is too slow, then the glass will be crystallized into micro-structured glass ceramics, which have dimensions greater than 1000 nm. Hence, precise temperature control is required so that cooling is fast enough to prevent crystallization into micro-structured crystallites, but yet slow enough to allow creation of the nano-crystallites.

The gamma-ray detection material produced using the temperature program in FIG. 4 may be fabricated into different shapes such as fibers or strips for use in applications other than those relating to borehole logging. The shapes may be produced by extruding the glass matrix material through a die during the cool down period t₅ when the glass is still pliable. The die has an opening selected to produce the desired shape as the glass material is forced through it.

Since heavy glass matrix materials may exhibit strong optical absorption in the ultraviolet (UV) region and blue region of visible light, emission wavelengths due to scintillation are generally located in the green or yellow regions of light wavelengths.

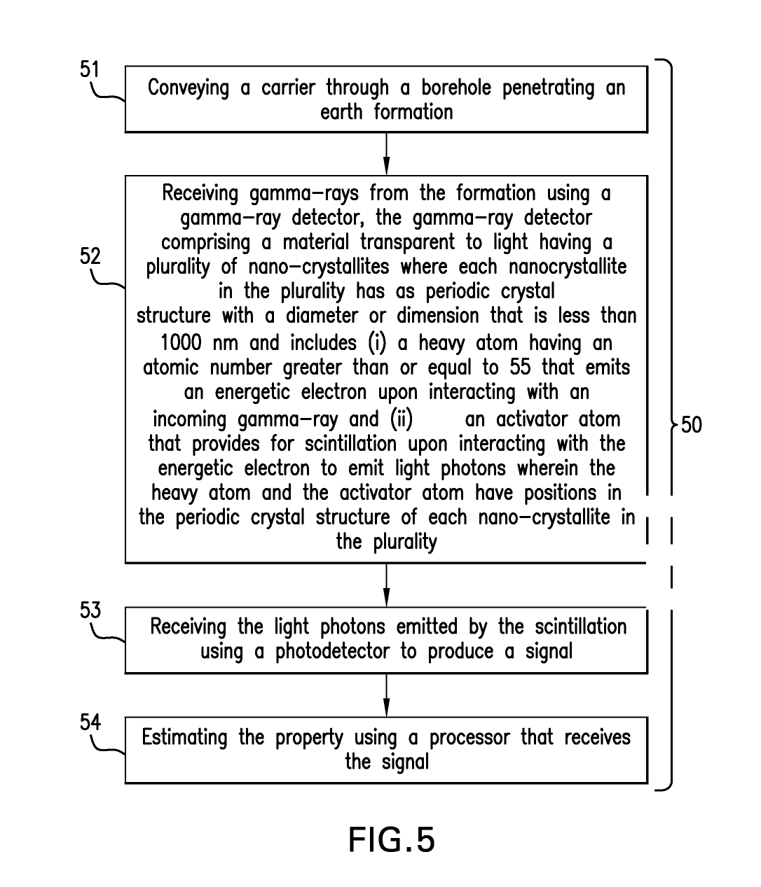

FIG. 5 is a flow chart of a method for estimating a property of an earth formation penetrated by a borehole. Block 51 calls for conveying a carrier through the borehole. Block 52 calls for receiving gamma-rays from the formation using a gamma-ray detector. The gamma-ray detector includes a material transparent to light having a plurality of nano-crystallites where each nano-crystallite in the plurality has as periodic crystal structure with a diameter or dimension (i.e., outside dimension) that is less than 1000 nm and includes (i) a heavy atom having an atomic number greater than or equal to 55 that emits an energetic electron upon interacting with an incoming gamma-ray and (ii) and an activator atom that provides for scintillation upon interacting with the energetic electron to emit light photons wherein the heavy atom and the activator atom have positions in the periodic crystal structure of each nano-crystallite in the plurality. Block 53 calls for receiving the light photons emitted by the scintillation using a photodetector to produce a signal. Block 54 calls for estimating the property using a processor that receives the signal.

The gamma-ray detector having the gamma-ray detection material disclosed herein provides many advantages over prior art gamma-ray detectors in use in the oil and gas industries and overcomes the disadvantages of the prior art detectors described below. Currently, the oil and gas downhole logging industry uses several different detector types to detect gamma rays. Traditionally, such detectors contain just a few types of inorganic gamma sensitive scintillation crystals such as NaI(Tl), CsI(Na), CsI(Tl) and BGO. But with time, less and less conveniently placed oil and gas reservoirs are left and it becomes more and more difficult to access hydrocarbon deposits. More sophisticated drilling and evaluation methods are required than needed in the past. Very often much higher temperature (175° C. or even more) must be managed during downhole measurements.

All these prior art scintillation crystals have disadvantages for high temperature applications. Single scintillation crystals such as NaI(Tl), CsI(Na), CsI(Tl) are hygroscopic and have low hardness. They need careful vibration and hygroscopic protection. Moreover, in the range 170-190° C. alkali halide materials demonstrate a peak of the allocation of water from the material. It deteriorates surfaces of the crystal and complicates detector calibration. BGO is hard and mechanically durable crystal, but its scintillation yield has a dramatic fall with temperature increase. BGO based scintillation detector requires careful and bulky thermo-insulation. An alternative to inorganic scintillator based detectors for high temperature applications use Geiger-Muller tubes for gamma ray detection. However, they have low efficiency of detection of γ-rays (about 1.5%).

In order to overcome such challenges, several new scintillators were tested for application in the industry in recent years, namely gadolinium silicate (GSO), gadolinium-yttrium silicate (GYSO) and most recently LaBr₃:Ce. Among them, the former material has better temperature dependence of the response. But lanthanum bromide possesses a set of drawbacks such as having internal radioactivity of scintillator material and being strongly hygroscopic.

In some downhole logging tools, for instance used in Logging While Drilling (LWD), an average lifetime of scintillation detector module is about one year or even less because of damage to hygroscopic scintillation crystal due to destruction of the housing under the high vibration conditions downhole. In addition, each single crystalline scintillator of non-cubic symmetry has non-isotropic thermal expansion and, as a result, only cylindrical single crystal scintillation elements can survive thermal cycling and vibration in downhole conditions. Also, it is often of great benefit to fill all the space available in a detector with scintillation material in order to maximize the amount of material available for detection. However, the cylindrical shape requirement may not be the ideal shape for making use of the all the available space. Composite materials having transparent glass embedded with nanoparticles of only scintillator material still remain an amorphous substance and, thus, will expand isotropically with the temperature increase.

The glass matrix detection material having nano-crystallites as disclosed herein can be produced in various shapes in order to make maximum use of the space available for this material in a detector in a downhole tool, thus increasing the probability of detecting an incoming gamma-ray. Further, having heavy atoms and activator atoms in the glass matrix surrounding the nano-crystallites also increases the probability of detecting an incoming gamma-ray.

It can be appreciated that the gamma-ray composite detection material disclosed herein may include glass ceramics and doping ions and may be used in devices and methods incorporating this material. Besides well logging applications, this material may be used in gamma-ray detectors in the medical imaging field, X-ray imaging field, and other fields requiring the detection or measurement of gamma-rays.

In support of the teachings herein, various analysis components may be used, including a digital and/or an analog system. For example, the downhole electronics 12 or the surface computer processing 13 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The term “couple” relates to a first component being coupled to a second component either directly or via an intermediary component. The term “configured” relates to one or more structural limitations of a device that are required for the device to perform the function or operation for which the device is configured.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for detecting a gamma-ray, the apparatus comprising:
a gamma-ray detection material comprising a material transparent to light having a plurality of nano-crystallites where each nano-crystallite in the plurality has as periodic crystal structure with a diameter or dimension that is less than 1000 nm and includes (i) a heavy atom having an atomic number greater than or equal to 55 that emits an energetic electron upon interacting with an incoming gamma-ray and (ii) and an activator atom that provides for scintillation upon interacting with the energetic electron to emit light photons wherein the heavy atom and the activator atom have positions in the periodic crystal structure of each nano-crystallite in the plurality; and
a photodetector optically coupled to the gamma-ray detection material and configured to detect the light photons emitted from the scintillation and to provide a signal correlated to the detected light photons.

2. The apparatus according to claim 1, wherein the heavy atoms in each nano-crystallite comprise heavy atoms of a single type.

3. The apparatus according to claim 2, wherein the heavy atoms of a single type comprise one selection from a group consisting of Pb, Bi, Ba, Hf, Au, Pt, and I.

4. The apparatus according to claim 2, wherein the material transparent to light comprises heavy atoms external to the nano-crystallites that are the same as the heavy atoms in the nano-crystallites.

5. The apparatus according to claim 4, wherein the material transparent to light further comprises heavy atoms of another type that are external to the nano-crystallites.

6. The apparatus according to claim 1, wherein activator atom comprises Ce+3.

7. The apparatus according to claim 1, wherein the activator atom comprises Pr+3.

8. The apparatus according to claim 1, wherein the activator atom comprises Eu+3.

9. The apparatus according to claim 1, wherein each nano-crystallite in the plurality has a diameter or dimension in a range of 100 nm to less than 1000 nm.

10. The apparatus according to claim 9, wherein a diameter or dimension of each of the nano-crystallites in the plurality is at least four times smaller than a wavelength of light emitted by the scintillation.

11. The apparatus according to claim 1, wherein two or more of the nano-crystallites in the plurality are in contact with each other.

12. The apparatus according to claim 1, wherein the material transparent to light comprises a glass system containing the plurality of nano-crystallites.

13. The apparatus according to claim 1, where in the gamma-ray detection material is fabricated by a process comprising:
mixing the material transparent to light with heavy atoms and activator atoms; and
subjecting the mixture to a heat treatment process that includes a plurality of time intervals having a corresponding temperature profile.

14. The apparatus according to claim 13, wherein gamma-ray detection material comprises a selected shape obtained by extruding the gamma-ray detection material through a die during the heat treatment process.

15. The apparatus according to claim 14, wherein the gamma-ray detection material comprises a shape that is at least one of a fiber and a strip.

16. An apparatus for estimating a property of an earth formation penetrated by a borehole, the apparatus comprising:
a carrier configured to be conveyed through the borehole;
a gamma-ray detector disposed at the carrier and comprising a gamma-ray detection material, the gamma-ray detection material comprising a material transparent to light having a plurality of nano-crystallites where each nano-crystallite in the plurality has as periodic crystal structure with a diameter or dimension that is less than 1000 nm and includes (i) a heavy atom having an atomic number greater than or equal to 55 that emits an energetic electron upon interacting with an incoming gamma-ray and (ii) and an activator atom that provides for scintillation upon interacting with the energetic electron to emit light photons wherein the heavy atom and the activator atom have positions in the periodic crystal structure of each nano-crystallite in the plurality;
a photodetector optically coupled to the neutron detection material and configured to detect the light photons emitted from the scintillation and to provide a signal correlated to the detected light photons; and
a processor configured to estimate the property using the signal.

17. The apparatus according to claim 16, wherein the processor is further configured to count pulses of at least one of electric current and voltage to estimate the property.

18. The apparatus according to claim 17, wherein the processor is further configured to compare the counted pulses of at least one of electric current and voltage to a reference to estimate the property.

19. The apparatus according to claim 16, wherein the carrier comprises a wireline, a drill string or coiled tubing.

20. A method for estimating a property of an earth formation penetrated by a borehole, the method comprising:
conveying a carrier through the borehole;
receiving gamma-rays from the formation using a gamma-ray detector, the gamma-ray detector comprising a material transparent to light having a plurality of nano-crystallites where each nano-crystallite in the plurality has as periodic crystal structure with a diameter or dimension that is less than 1000 nm and includes (i) a heavy atom having an atomic number greater than or equal to 55 that emits an energetic electron upon interacting with an incoming gamma-ray and (ii) and an activator atom that provides for scintillation upon interacting with the energetic electron to emit light photons wherein the heavy atom and the activator atom have positions in the periodic crystal structure of each nano-crystallite in the plurality;
receiving the light photons emitted by the scintillation using a photodetector to produce a signal; and
estimating the property using a processor that receives the signal.
